(19) United States
(12) Patent Application Publication
(10) Pub. No.: US 2023/0141423 A1
(43) Pub. Date: May 11, 2023

(54) SYSTEM AND METHOD FOR EXECUTION OF LIMIT TRADES ON DECENTRALIZED EXCHANGES

(71) Applicants: Fabrizio Fantini, London (GB); Joel Maynard Ward, Austin, TX (US); Marco Manzi, Rome (IT)

(72) Inventors: Fabrizio Fantini, London (GB); Joel Maynard Ward, Austin, TX (US); Marco Manzi, Rome (IT)

(21) Appl. No.: 17/727,715

(22) Filed: Apr. 23, 2022

Related U.S. Application Data
(60) Provisional application No. 63/276,705, filed on Nov. 8, 2021.

(51) Int. Cl. G06Q 40/04; G06Q 20/36; G06Q 20/06

(52) U.S. Cl. CPC G06Q 40/04; G06Q 20/367; G06Q 20/065

(57) ABSTRACT

A system for execution of limit trades on decentralized exchanges comprising a computer service system configured for receiving from a client device a limit order for swapping a desired quantity of a first digital asset for a second digital asset at a desired target price. A smart contract on a blockchain network is then generated corresponding to the order. By depositing the desired quantity of the first digital asset the smart contracts creates a single-sided liquidity pool on the blockchain network. For real-time monitoring of price feeds the smart contract interacts with a decentralized oracle system. On finding one or more matches for the swapping at said target price the position is filled using liquidity pool. User receives the exact number of the second digital asset which the user wanted at the target price in exchange of the first digital asset without any price impact, liquidity fee or slippage.

### CROSS-REFERENCE TO RELATED APPLICATION

This application claims the benefit of U.S. Provisional Application No. 63/276,705, filed Nov. 8, 2021 the contents of which are incorporated herein by reference.

### FIELD OF THE INVENTION

The present invention in general is related to digital asset trading. More particularly, the present invention is related to a system and method which enables efficient transactions of digital financial assets on decentralized exchanges.

### BACKGROUND OF THE INVENTION

Decentralized Finance, or DeFi for short, refers to a financial system that runs autonomously without needing support from centralized intermediaries such as banks, brokerages, exchanges to provide financial services. Decentralized Finance platforms are built on top of blockchains and can fulfill specific financial functions determined by the smart contracts that make most of the processes follow automatically. One of the emerging types of DeFi protocols is decentralized exchanges.

A decentralized exchange (DEX) is a cryptocurrency exchange which allows for direct peer-to-peer cryptocurrency transactions to take place online securely and without the need for an intermediary. Trading occurs directly from the traders' wallets through smart contracts. Decentralized exchanges offer almost all and similar trading services that a centralized exchange can offer. Many decentralized exchanges offer a service known as token swap that allow users to buy and sell cryptocurrencies for traditional currencies or for other cryptocurrencies. However, due to the insufficient liquidity, swapping may not be possible sometimes. Also, such a situation may induce price impact which affects the trade over the market price of the underlying tokens. Price impact will be high when liquidity is low for a particular token pair. Then there is slippage which occurs when traders have to settle for a different price than what they initially requested due to a movement in price between the time the order enters the market and the execution of a trade. Another grave issue plaguing the decentralized exchanges is Front Running which is the act of placing a transaction in a queue with the knowledge of a future transaction. These kinds of problems associated with decentralized exchanges make execution of true Limit Orders a challenge.

Thus, there exists a need for a system and method that overcomes the above-mentioned disadvantages associated with execution of limit order on decentralized exchanges.

### OBJECTS OF THE INVENTION

It is, therefore, an object of the present invention to provide a system and method for minimizing cost of trading digital financial assets on decentralized exchanges.

Another object of the present invention is to provide a system and method for zero price impact trading on decentralized exchanges.

Another object of the present invention is to provide a system and method for enabling execution of limit orders on decentralized exchanges.

Another object of the present invention is to provide a system and method for eliminating slippage, liquidity fees and front-running on decentralized exchanges.

Still another object of the present invention is to enable creation of order books for trading on decentralized exchanges.

Another object of the present invention is to provide a system and method for maximizing value for money invested on trading on decentralized exchanges.

Another object of the present invention is to provide a system and method for adding stability to decentralized finance projects.

Another object of the present invention is to provide a system and method for safe and secured trading on decentralized exchanges.

Yet another object of the present invention is to provide a system and method for giving a user complete control on a target price on decentralized exchanges.

Details of the foregoing objects and of the invention, as well as additional objects, features and advantages of the invention will become apparent to those skilled in the art upon consideration of the following detailed description of the preferred embodiments exemplifying the best mode of carrying out the invention as presently perceived.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The present invention is directed to a decentralized finance product. The system and method of the present invention (also referred to as “CivTrade”) enables taking limit orders from clients through its user interface. The system then creates an order book as traders would do on a traditional exchange by specifying the target size and price of each trade. The system subsequently programmatically opens specially designed liquidity pools, and then uses a custom-developed job request to engage decentralized oracles for programmatically monitoring the blockchain in real-time leading to optimized execution of each trade. When the system completes a trade, the user funds are ready to be claimed with a few simple clicks.

To the accomplishment of the foregoing and related ends, certain illustrative aspects of the disclosed invention are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

In order to describe the manner in which features and other aspects of the present disclosure can be obtained, a more particular description of certain subject matter will be rendered by reference to specific embodiments that are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 illustrates a general architecture of a zero-impact limit trade system that operates in accordance with an embodiment of the present invention;

FIG. 2 illustrates a general architecture of a client device that operates in accordance with an embodiment of the present invention;

FIG. 3 illustrates a block representation of the process of limit trade execution by creation of single-sided liquidity pool by a smart contract deployed by the zero-impact limit trade computer service system and by monitoring of price feeds obtained from a decentralized oracle system;

FIG. 4 illustrates a flowchart depicting the general steps associated with the method for zero-impact limit trade system in accordance with an embodiment of the present invention;

FIGS. 5A-5B illustrate non-limiting exemplary screenshots of Graphical User Interface (GUI) or user interface provided by the present invention which allow a user to select a first digital asset and enter a desired amount/quantity of the first digital asset for transaction in accordance with an embodiment of the present invention;

FIGS. 6A-6B illustrate non-limiting exemplary screenshots of the user interface provided by the present invention for selection of a second type of digital asset for swapping with the first digital asset in accordance with an embodiment of the present invention;

FIGS. 7A-7B illustrate non-limiting exemplary screenshots of the user interface for entering a target price for a selected digital asset and initiating approval process for the same in accordance with an embodiment of the present invention;

FIGS. 8A-8B illustrate non-limiting exemplary screenshots of the user interface for approving the target price from digital wallet and setting the trade parameters in accordance with an embodiment of the present invention;

FIGS. 9A-9B illustrate non-limiting exemplary screenshots of the user interface for giving confirmation of the trade amount on digital wallet and for reviewing the status of trade being executed in accordance with an embodiment of the present invention;

FIG. 10 illustrates a non-limiting screenshot of the user interface showing a comprehensive overview of the limit order trade being executed with other relevant parameters in accordance with an embodiment of the present invention; and

FIG. 11 illustrates a non-limiting screenshot of the user interface showing an order book for limit orders in accordance with an embodiment of the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business-related constraints including compliance with statutory and regulatory requirements, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In the context of the present invention the term “Digital Asset” is used to refer to cryptocurrency coins or tokens which represent a type of money, and it may also include tokens that are transferable and represent ownership of tangible assets. Again, the terms “Limit Order” or “Limit Trade” are used hereinafter to refer to a type of order that investors can use to set parameters for buying and selling of the digital assets. A limit order or limit trade enables buying or selling of a digital asset with a restriction on the maximum price to be paid or the minimum price to be received.

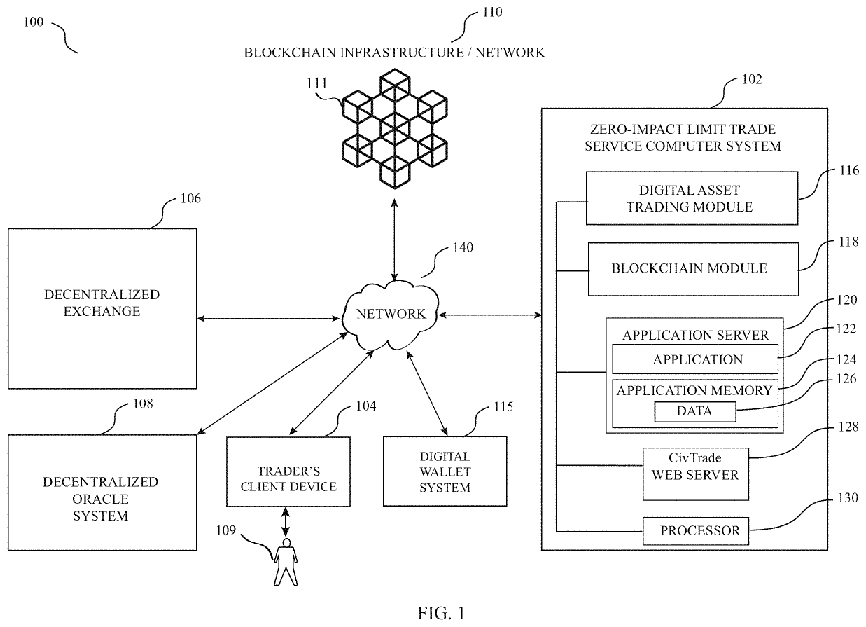

Reference to FIG. 1, the system 100, for optimizing cost of digital asset trade execution on decentralized exchange platforms, in accordance with an embodiment of the present invention is configured to operate as part of a blockchain infrastructure 110. The blockchain infrastructure 110 may include a publicly managed (permissionless) blockchain infrastructure/network (such as Ethereum or the like) or a privately managed (permissioned) infrastructure/network (e.g., a blockchain managed by an organization). Blockchain infrastructure/network 110 may be accessible to zero-impact limit trade service computer system 102, decentralized exchange 106, client device 115 and other computers over the network 140. In one embodiment, blockchain infrastructure 110 is implemented by a plurality of computer servers or nodes 111 that implement a predefined, distributed protocol, such that no single computer or small group of computers may gain control over the blockchain infrastructure 111. Thus, the blockchain infrastructure 110 commonly includes predefined behavior according to a known protocol without control by any central authority. In some implementations, each of the nodes 111 may be configured to mine and thereby validate transactions submitted to the blockchain infrastructure 110. The zero-impact limit trade service computer system 102 and the client device 104 may be configured to execute transactions on the blockchain infrastructure 110. As is further discussed below, the transactions may include placing of limit orders, selling of a digital asset and buying of a digital assets etc.

Reference to FIG. 1, the zero-impact limit trade service computer system 102, in some embodiments, can be a node of the blockchain infrastructure/network 110 and it performs a portion or all of the processing steps for zero-impact limit trade described herein in response to the processor 130 executing computer readable program codes having one or more sequences of one or more instructions contained in the application memory 124. Zero-impact limit trade service computer system 102 may include one computer or multiple computers with different software components operating on different computers/nodes of the blockchain infrastructure. The application server 120 includes an application 122 including executable application code for performing the functions of the application. Application 122 may store data 126 in application memory 124. Application memory 124 may include internal tables for data related to order books, for example, or other data structures for maintaining and manipulating data used by application 122. Application memory 124 may store data corresponding to simple or complex data structures. One or more physical processors 130 in a multi-processing arrangement may also be employed to execute the sequences of instructions contained in memory. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the nodes such as in zero-impact limit trade service computer system 102. A module (whether hardware, software, or a combination thereof) may be designed to implement or execute one or more particular functions. The term “computer readable medium” as used herein refers to any medium that participates in providing instructions to the processors for execution. A computer readable medium may take many forms, including but not limited to, non-volatile media, volatile media, and transmission media. Non-volatile media includes, for example, optical, magnetic disks, and magneto-optical disks, such as the hard disk or the removable media drive.

The CivTrade web server 128 is a system that sends out Web pages containing electronic data files in response to Hypertext Transfer Protocol (HTTP or HTTPS) requests or similar protocol requests from remote browsers (i.e. browsers installed in the client devices) or in response to similar requests made through a mobile app or mobile application of the present invention installed on a client device. The web server 128 can communicate with the mobile app of the present invention and/or with a web browser installed on client device 104 to provide the user interface required for providing the zero-impact limit trade service.

The digital asset trading module 116 handles the processes for limit trade execution. The blockchain module 118 communicatively interfaces the zero-impact limit trade service system 102 with other blockchain participating nodes and client devices so as to enable the zero-impact limit trade service computer system 102 to participate in the available blockchain protocols by acting as a blockchain protocol compliant node. This permits the zero-impact limit trade service computer system 102 to provide blockchain services to the other participating nodes and client devices. In example embodiments, the blockchain module 118 may include instructions executable by the processor(s) 130 to cooperate with one or more blockchain nodes/client devices/decentralized exchanges/decentralized oracle systems for execution of zero-impact limit trade. The instructions may also enable the processor(s) 130 to generate the smart contract(s) that are incorporated on the blockchain 110 with respect to the execution of zero-impact trade limit.

The blockchain module 118 is configured to generate smart contracts as transaction blocks on a blockchain network via a high-level application and programming language (Solidity, for example) which can be deployed to the blockchain for execution by zero-impact limit trade service computer system 102 using a virtual machine deployed in conjunction with the blockchain 110. The smart contracts may comprise self-executing instructions, which are guaranteed to occur according to their specification (e.g., code) by implementation on the blockchain 110 and execution by zero-impact limit trade service computer system 102 without requiring an external authority. In the context of both permissioned and permissionless blockchains, the term smart contract is often used to refer to software programs that run on a blockchain. The smart contracts include executable codes which are registered, stored, and/or replicated on the blockchain 110. A transaction is an execution of the smart contract code which can be performed in response to conditions associated with the smart contract being satisfied. In the context of the present invention, the code of the smart contract acts as a programmatically defined autonomous agent for zero-impact limit trade execution with its own persistent variables that get executed within the blockchain when the smart contract is referenced by a message and/or a transaction. Any modification to the blockchain ledger caused by the smart contract execution may be automatically replicated throughout the blockchain peers using one or more consensus protocols.

The decentralized exchange 106 of FIG. 1 operates in a decentralized manner to allow the users use of peer-to-peer (P2P) transactions of crypto digital assets. Examples of decentralized exchange 106 include Uniswap, PancakeSwap, 1 inch Exchange and Raydium etc.

The decentralized oracle system 108 is a third-party service provider which enables onboarding of information that exists outside the blockchain onto the blockchain. The decentralized oracle system 108 facilitates communication between the smart contracts deployed by the zero-impact limit trade service computer system 102 and the outside world in terms of receiving real-time data related to digital asset (cryptocurrency, for example) valuations. Examples of decentralized oracle system 108 include Chainlink, Witnet and Oraclize etc. The oracle layers verify on-chain data and then submit the aggregate data to the smart contracts.

Digital wallet system 115 can be a device, a physical medium, program or a service which stores the public and/or private keys for cryptocurrency transactions. Digital wallet system 115 allows user 109 to interact with blockchains for making purchases and transactions of digital assets. Coinbase, Exodus, Electrum, Mycelium are some of the examples of digital wallet system 115.

Although, the description of the system 100 for providing execution of zero-impact limit trade services may refer to terms commonly used in describing particular computer servers, the description and concepts equally apply to other processing systems, including systems having architectures dissimilar to that shown in FIG. 1.

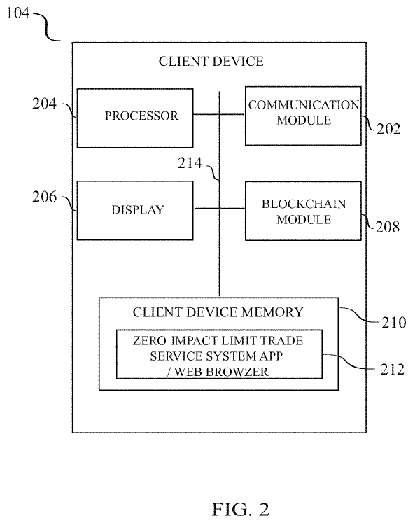

FIG. 2 illustrates a client device 104 suitable for use with the various embodiments. The components described with respect to the client device 104 enables communication with the zero-impact limit trade service computer system 102. As shown in FIG. 2, client device 104 may comprise a communication module 202, a processor 204, a display 206, a block chain module 208 and a client device memory 210. The memory 210 may include a non-transitory storage medium such as a disk drive, a flash drive, a solid state memory device, a memory circuitry, or some other memory device, in various forms of volatile and non-volatile memory storage, and may store processor-executable instructions, such as an operating system, computer programs, firmware, zero-impact limit trade service mobile application of the present invention or some other form of processor-executable instructions, which may include an operating system, utilities, drivers, network interfaces, applications, or some other type of software. The display 206 may display information, and may present the user interface of the present invention to receive input and display information. The communication module 202 may include various elements to enable the client device 104 to communicate with another device and/or with a communication network (such as the communication network 140 of FIG. 1) including interfaces, transceivers, and other hardware and/or related software. The processor 204 may control the operation of the display 206, the communication module 202, and the client device memory 210, over a communication link 214 such as a bus or other communication link. The client device memory 210 may store a browser application and/or the zero-impact limit trade service mobile app 212. The browser application and/or the mobile app 212 may enable the client device 104 to communicate with a web server (e.g., the web server 128 of FIG. 1).

The zero-impact limit trade service mobile application or “mobile app” is a computer program that may be downloaded and installed on client devices using methods known in the art. It can also be a set of instructions programmed on the hardware of the client device or a pre-loaded computer program or firmware or any such native application supplied with the client device. Hereinafter, the mobile app/native application of the present invention and/or the user interface of the invention presented through a web browser by the system 102 for execution of zero-impact limit trade services are alternatively and interchangeably referred to as CivTrade app. The CivTrade app enables one or more users to access various features related to the system for zero-impact limit trade service. Examples of client device 104 may include, but not limited to mobile devices, tablets, hand-held or laptop devices, smartphones, personal digital assistants, desktop computer or any similar computing devices.

The zero-impact limit trade service computer system 102 communicates with the client devices over the network 140 to present a user interface for the zero-impact limit trade system of the present invention. The user interface of the zero-impact limit trade system of the present invention can be presented on the client device through a web browser or through the native mobile application communicating with the zero-impact limit trade service computer system 102 and is used for displaying, entering and/or managing data and for interacting with the system. As used herein, the term “network” generally refers to any collection of distinct networks working together to appear as a single network to a user. The term also refers to the so-called world wide “network of networks” or Internet which is connected to each other using the Internet protocol (IP) and other similar protocols. As described herein, the exemplary public network 140 of FIG. 1 is for descriptive purposes only and it may be wired or wireless. Although, the description may refer to terms commonly used in describing particular public networks such as the Internet, the description and concepts equally apply to other public and private computer networks, including systems having architectures dissimilar to that shown in FIG. 1. The inventive idea of the present invention is applicable for all existing cellular/telecommunication network topologies or respective communication standards, in particular GSM, UMTS/HSPA, LTE and future standards.

The graphical user interface (GUI) or user interface provided by the zero-impact limit trade service computer system 102 on the client devices through a web browser or mobile app provides a user selectable menu comprising one or more options for selection of a pair of tokens/digital assets to be swapped (selection of first digital asset and second digital asset), selection of a desired number/quantity of the token/digital asset to be swapped, selection of a desired target price and selection of a pre-closing option for closing filling of the limit order while the order is being executed. The GUI may be utilized by the users for signing up, logging in, approving transaction in digital wallet, displaying order book, withdrawing funds and getting real time updates and alerts etc.

The components appearing in the zero-impact limit trade system 100 refer to an exemplary combination of those components that would need to be assembled to create the infrastructure in order to provide the tools and services contemplated by the present invention.

An embodiment of the present invention will be described by way of a non-limitative example and with reference to the accompanying drawings. The zero-impact limit trade system 100 of the present invention will be described herein in the context of a person 109 intending to trade or swap a digital financial asset. The terms “Trade”, “Exchange” and “Swap” are interchangeably and alternatively used herein to refer to exchanging one cryptocurrency/token/digital asset for the equivalent value of another cryptocurrency/token/digital asset.

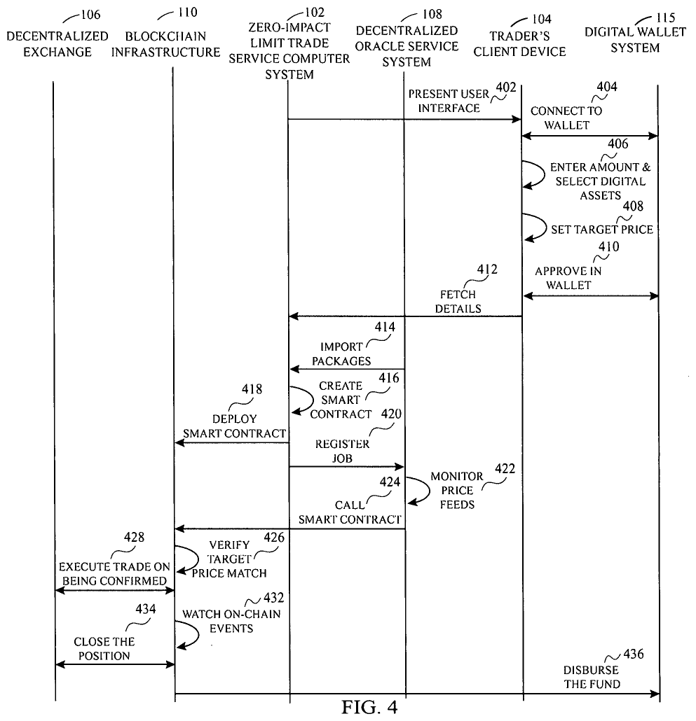

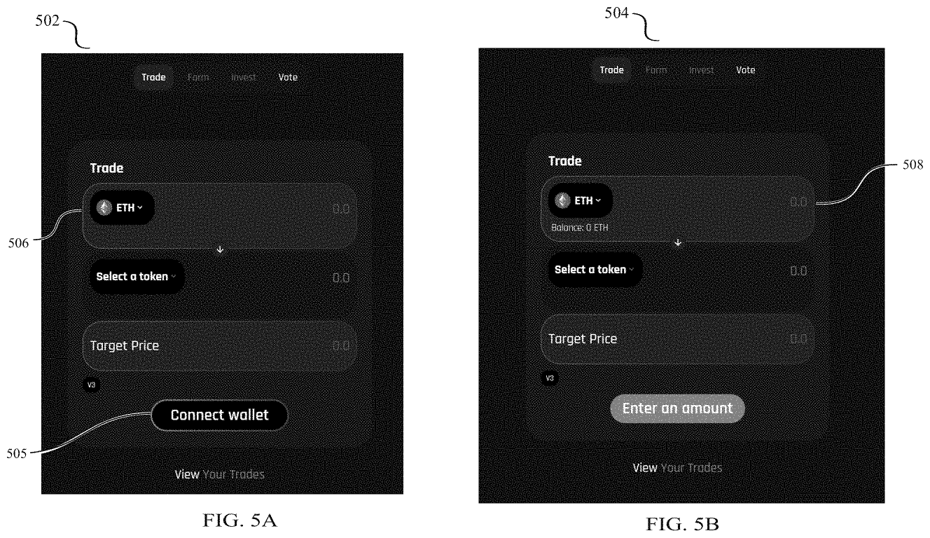

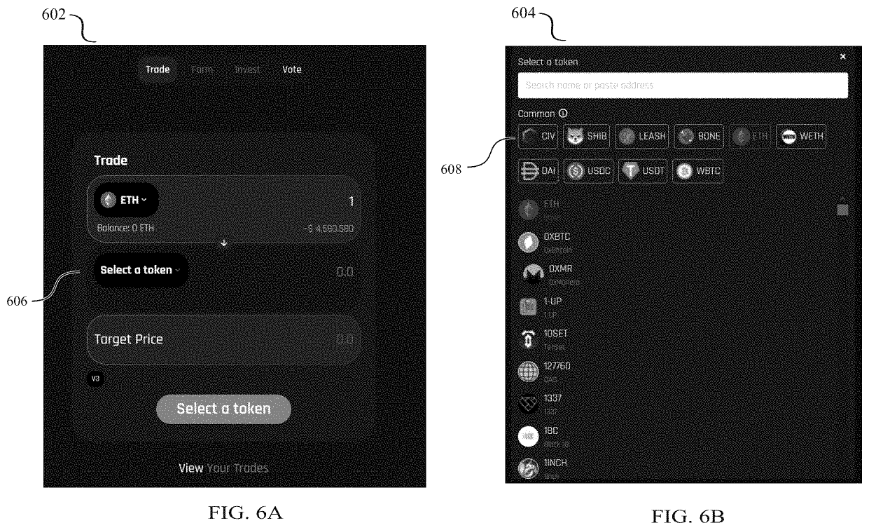

The zero-impact limit trade service computer system 102 presents a user interface on the user's/trader's client device 104 though a web browser or through the CivTrade app, as in step 402 of FIG. 4. The user 109 may get him/her registered with the zero-impact limit trade system by submitting and verifying required information. Once logged-in, as shown in exemplary screenshot 502 of the user interface in FIG. 5A, the user 109 is required to connect the zero-impact limit trade account to a digital wallet by using the button 505, as in step 404. For this, the zero-impact limit trade service computer system 102 interacts with the digital wallet system 115 of FIG. 1. The user 109 is then required to select a first digital asset (digital asset ETH in this example) using the button 506 and enter, using the button 508, a desired amount or number/quantity of the first digital asset (desired quantity of first digital asset to be swapped is 1 in the present example) which the user 109 wants to swap, as shown in the exemplary screenshots of the user interfaces 502 and 504 in FIGS. 5A and 5B respectively. The user 109 is then required to select the second digital asset using the button 606 on the user interface (as in exemplary screenshot 602 of FIG. 6A), as shown in step 406 of FIG. 4. As depicted in exemplary screenshot 604 of the user interface in FIG. 6B, the user 109 is offered a number of digital asset options to select from for the swap. In the present example, digital asset “CIV”, indicated by 608, has been selected by the user 109 for the swap.

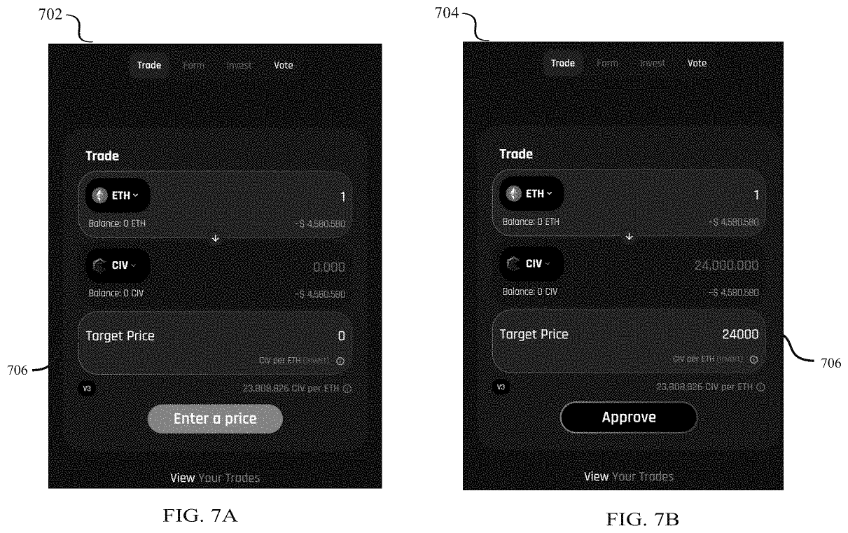

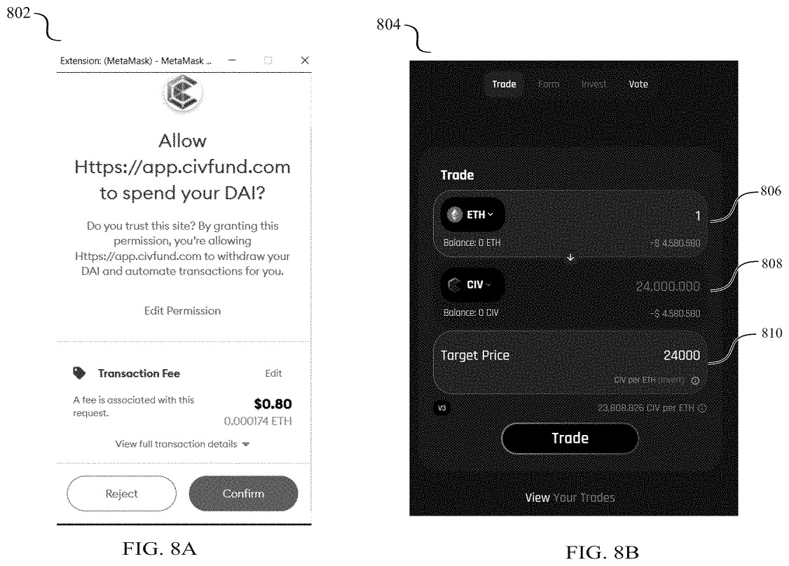

For limit orders/trades, it is required that a specific/target/limit price is set by the user. In the present example, at step 408 of FIG. 4, the user 109 sets the target price as “24000” using the button 706 as illustrated in the exemplary screenshots 702 and 704 of the user interface in FIGS. 7A and 7B respectively. The target price is then required to be approved, as in step 410 of FIG. 4, in the digital wallet associated with the first digital asset as shown in exemplary screenshot 802 of the user interface in FIG. 8A.

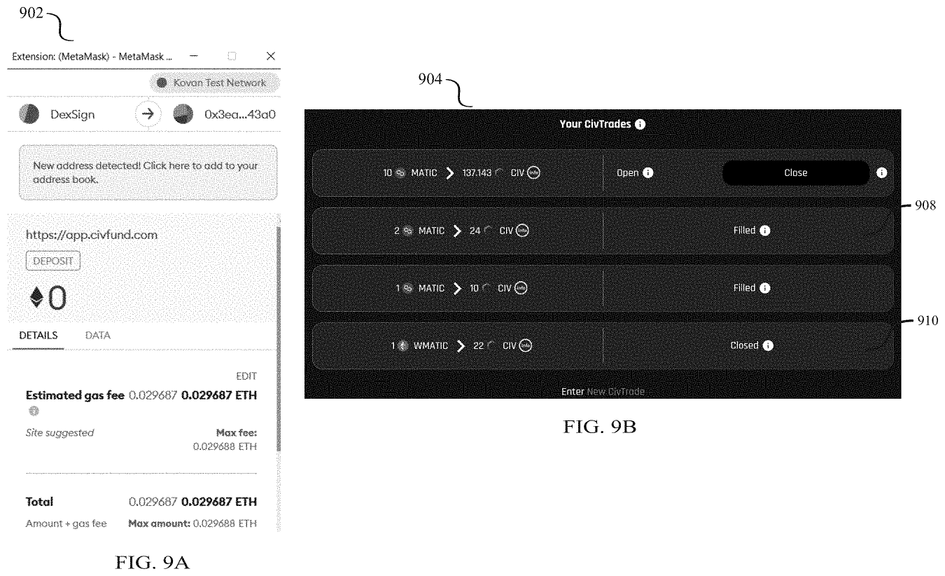

Before the zero-impact limit trade service computer system 102 initiates the trading process, the user 109 is needed to confirm the trade initiation and, also, approve the same, as in step 410 of FIG. 4, in the digital wallet as shown in the exemplary screenshots 804 of FIGS. 8B and 902 of FIG. 9A respectively. In the present example, as shown in screenshot 804 of the graphical user interface in FIG. 8B, the position taken by the user for the limit trade involves one number of first digital asset (reference 806) to be swapped for a second digital asset (reference 808) at a target price of 24000 (reference 810).

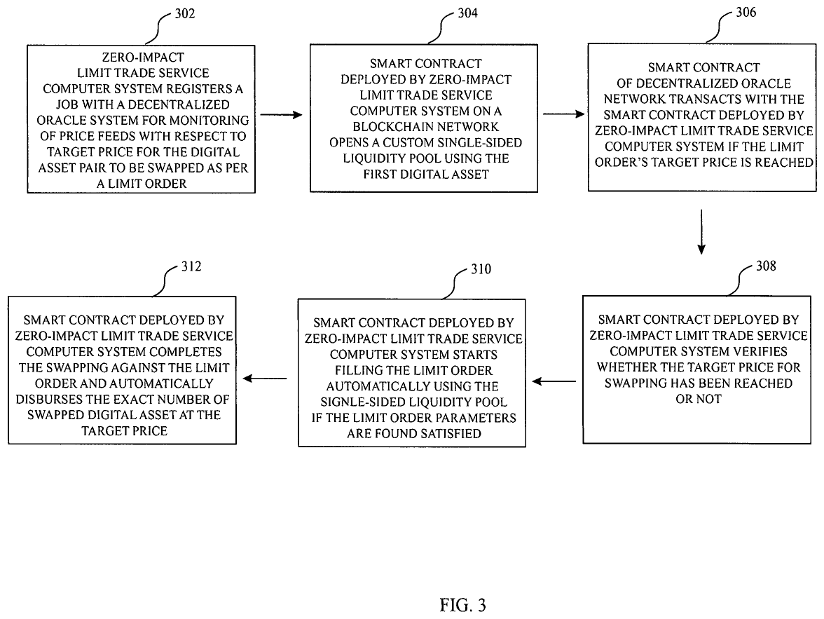

The zero-impact limit trade service computer system 102 then fetches the limit trade request information, as in step 412 of FIG. 4, and processes it for the next step. For the real-time monitoring of one or more price feeds/data to find one or more matches for the swapping of the exemplary pair of tokens ETH/CIV (first digital asset/second digital asset) at the target price, the zero-impact limit trade service computer system 102 takes help from the decentralized oracle system 108. To create a smart contract that is compatible with the decentralized oracle system 108, the zero-impact limit trade service computer system 102 imports the packages/codes/kits from the decentralized oracle system 108, as in step 414 of FIG. 4. A smart contract, which is compatible for interaction with the decentralized oracle system 108, is then generated by the zero-impact limit trade service computer system 102 for the intended trade/swap as in step 416. The decentralized oracle codes are executable on the blockchain network to give indications of events extrinsic to the blockchain network. The smart contract is subsequently deployed on the blockchain infrastructure 110 as in step 418 as a transaction block. Also, a job/task request (Upkeep job for Chainlink, for example) is simultaneously registered, as in step 420 of FIG. 4, by the zero-impact limit trade service computer system 102 with the decentralized oracle system 108 for receiving the real-time off-chain info on the digital asset/token/crypto pair to be swapped at the set target price of the limit order. Block 302 of FIG. 3 represents this step. The smart contract automatically opens a custom made one-sided liquidity pool in the decentralized exchange (Uniswap V3, for example) on behalf of the trader/user 109 for the trade/swap. This step is shown in block 304 of FIG. 3. This single-sided/one-sided liquidity pool, opened with a narrow range defined around the target price of the limit order, does not let any price impact on the trade i.e. the user receives the exact number of the purchased digital asset (second digital asset) at the set target price which the user defines for the sold digital asset (first digital asset). In the present example, the user wants to swap ETH (first digital asset) for CIV (second digital asset) i.e. buy CIV token using ETH token. So, the user deposits only the first digital asset ETH by approving on his/her digital wallet (first digital wallet) and the single-sided liquidity pool is created by depositing only this first digital asset ETH to the liquidity pool.

The decentralized oracle system 108 continuously monitors the price of the swap token pair in real time as in step 422 and checks if the smart contract requires any work to be done and calls the smart contract, as in step 424 of FIG. 4, as soon as the market moves to the target price set by the user 109. Block 306 of FIG. 3 represents this step. The blockchain infrastructure 110 then verifies the target price match as in step 426 of FIG. 4 (also, block 308 of FIG. 3). If a price match is confirmed i.e. if the decentralized oracle system 108 confirms that the limit order conditions are fulfilled i.e. the market has moved to the target price set by the user 109, then the trade is executed i.e. the limit order execution is started by swapping the first digital asset (ETH in the present example) for the second digital asset (CIV in the present example) at the target price, as shown in block 310 of FIG. 3 and in step 428 of FIG. 4, using the one-sided liquidity pool which was already created. Every such transaction is broadcasted to the blockchain network 110. Each of the one or more price feeds is a block on the blockchain network corresponding to a price feed update transaction on a price of the second digital asset with respect to the first digital asset and their real-time monitoring is continued until the trade is filled i.e. the limit order is completely filled by swapping all of the first digital asset for the second digital asset. The smart contract deployed by the zero-impact trade service computer system 102 registers/recognizes/defines the first digital wallet i.e. the digital wallet associated with the first digital asset as the liquidity provider for this trade, and, hence, the applicable liquidity provider fee debited from the second digital wallet associated with the second digital asset is credited to the first digital wallet of the user 109.

During the time the trade occurs, the zero-impact limit trade service computer system 102 monitors the on-chain activities against the trade as in step 432 of FIG. 4. As in step 434 of FIG. 4, the position is closed, automatically if filled completely (as shown by button 908 in FIG. 9B), or partially if instructed by the user 109 as shown by button 910 in exemplary screenshot 904 of the user interface in FIG. 9B. Block 312 of FIG. 3 represents this step. The fund i.e. the second digital asset if the position is filled or the first digital asset if the position is closed before the start of the trade/swap or combination of the first digital asset and the second digital asset if the swap is closed before the position is filled is thereafter sent to the first digital wallet directly as in step 436 of FIG. 4.

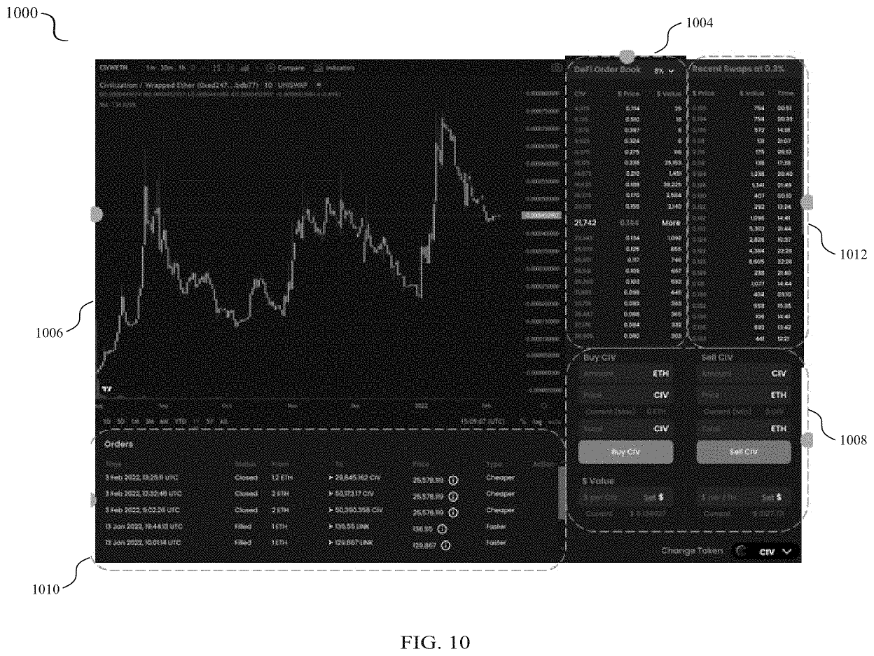

The graphical user interface presented by the present invention enables users to view numerous trade related information in real-time and also lets users to interact with the system. FIG. 10 shows a screenshot 1000 of such a graphical user interface. The exemplary interface shows a limit order book 1004, a price chart 1006, an order placing option 1008, a manage order section 1010 and a recent swap history section 1012. The price chart 1006 gives a graphical representation of the prices of a pair of tokens/digital assets over a selected period of time. This dynamic chart can be explored at different time intervals, using the dedicated menu showing default options (1 minute, 30 minutes, 1 hour, 1 day etc., for example). Limit order placing option 1008 includes buttons for selecting a type of order (limit order or market order, for example), for setting a target price and for setting the value of a token in fiat currency (USD in the present example). The orders can be managed (checking status of the orders or closing an order, for example) in real time using the manage order section 1010. Recent history of swaps in a liquidity pool can be viewed in the swap history section 1012.

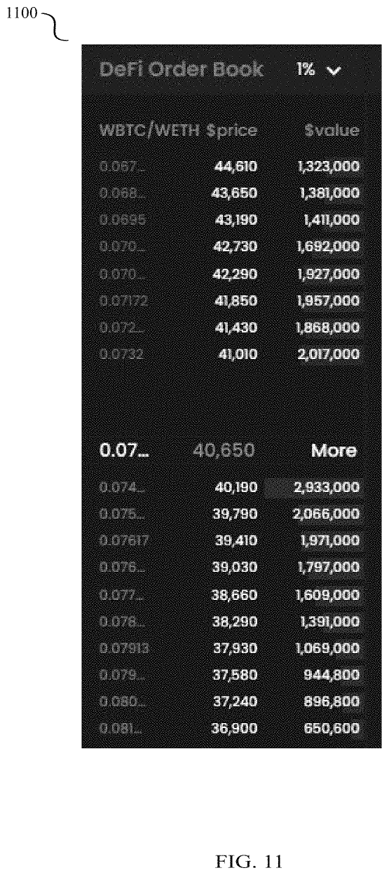

FIG. 11 shows an enlarged view 1100 of the order book 1004 of FIG. 10 with an exemplary pair of tokens/digital assets different from that is shown in order book 1004. The order book 1004 or 1100 comprises real time details of limit orders such as one or more order parameters including a value of the token/digital asset (second digital asset) to be bought in fiat currency and/or in terms of the token/digital asset (first digital asset) to be sold, and a value of the limit orders in fiat money. For example, it shows the second digital asset (e.g. WBTC) at each price level assuming a constant fiat (USD) value of the other token i.e. first digital asset (e.g. WETH) at its current market value. The displayed data can be spaced across price levels based on user-defined ranges, e.g. 1% to show WBTC/WETH prices in 1% increments, summing all ticks around that price point e.g. of 0.067 WBTC per WETH+/−0.5%. The limit order book of the present invention maintains a live record of the limit orders and displays their changes in real-time. For this, the smart contract deployed by the present invention updates the data in specific intervals (in every 15 seconds, for example) to let at least one new block to be mined by the blockchain network 110.

Thus, as described above, present invention makes it possible execution of real limit trade on decentralized exchanges which has been possible only on centralized exchanges so far. The system optimizes the cost of executing limit orders on decentralized exchanges and offers the users superior benefits by eliminating price impact, liquidity fees, risk of slippage and front-running.

Flowchart is used to describe the steps of the present invention. While the various steps in the flowchart are presented and described sequentially, some or all of the steps may be executed in different orders, may be combined or omitted, and some or all of the steps may be executed in parallel. Further, in one or more of the embodiments of the invention, one or more of the steps described above may be omitted, repeated, and/or performed in a different order. In addition, additional steps, omitted in the flowcharts may be included in performing this method. Accordingly, the specific arrangement of steps shown in FIGS. 3 and 4 should not be construed as limiting the scope of the invention.

What is claimed is:

1. A system for execution of limit trades on decentralized exchanges, said system comprising:
a zero-impact limit trade computer service system having at least one hardware processor and a non-transitory machine-readable storage medium having an executable computer readable program code which when executed by said at least one hardware processor configure said zero-impact limit trade computer service system for:
receiving, from a client device, a limit order for a swapping of a desired quantity of a first digital asset for a second digital asset at a desired target price;
generating a smart contract as a transaction block on a blockchain network corresponding to said limit order;
creating a liquidity pool by said smart contract by depositing said desired quantity of said first digital asset to said liquidity pool;
transacting with one or more decentralized oracle systems by said smart contract for real-time monitoring of one or more price feeds to find one or more matches for said swapping at said target price; and
triggering an execution of said limit order by said smart contract on said blockchain network by starting a filling of said limit order by swapping of said first digital asset for said second digital asset using said liquidity pool if said one or more matches for said desired target price are found.

2. The system of claim 1, wherein said executable computer readable program code includes instructions for displaying a graphical user interface comprising a user selectable menu on said client device, said user selectable menu comprising one or more options for selection of said first digital asset, selection of said second digital asset, selection of said desired quantity, selection of said desired target price and selection of a pre-closing option for closing said filling of said limit order.

3. The system of claim 2, wherein said graphical user interface further comprises an order book having real time details of a plurality of said limit orders, said real time details comprising one or more order parameters including a value of said second digital asset in fiat money, a value of said second digital asset in terms of said first digital asset and a value of said limit order in fiat money.

4. The system of claim 1, wherein each of said one or more price feeds is a block on said blockchain network corresponding to a price feed update transaction on a price of said second digital asset.

5. The system of claim 1, wherein said real-time monitoring of said one or more price feeds is continued until said filling of said limit order is completed by swapping all of said first digital asset for said second digital asset.

6. The system of claim 1, wherein said liquidity pool is created within a defined specific range around said target price as per one or more preset rules maintained in said smart contract.

7. The system of claim 1, wherein said at least one hardware processor is further configured to define a first digital wallet associated with said first digital asset used for placing said limit order from said client device to be a liquidity provider.

8. The system of claim 7, wherein a liquidity fee collected from a second digital wallet associated with said second digital asset against said swapping of said second digital asset for said first digital asset from said liquidity pool is credited to said first digital wallet associated with said first digital asset.

9. A method for execution of limit trades on decentralized exchanges, said method comprising:
receiving, by a zero-impact limit trade computer service system from a client device, a limit order for a swapping of a desired quantity of a first digital asset for a second digital asset at a desired target price;
generating a smart contract as a transaction block on a blockchain network corresponding to said limit order;
creating a liquidity pool by said smart contract by depositing said desired quantity of said first digital asset to said liquidity pool;
transacting with one or more decentralized oracle systems by said smart contract for real-time monitoring of one or more price feeds to find one or more matches for said swapping at said target price; and
triggering an execution of said limit order by said smart contract on said blockchain network by starting a filling of said limit order by swapping of said first digital asset for said second digital asset using said liquidity pool if said one or more matches for said desired target price are found.

10. The method of claim 9, wherein said executable computer readable program code includes instructions for displaying a graphical user interface comprising a user selectable menu on said client device, said user selectable menu comprising one or more options for selection of said first digital asset, selection of said second digital asset, selection of said desired quantity, selection of said desired target price and selection of a pre-closing option for closing said filling of said limit order.

11. The method of claim 10, wherein said graphical user interface further comprises an order book having real time details of a plurality of said limit orders, said real time details comprising one or more order parameters including a value of said second digital asset in fiat money, a value of said second digital asset in terms of said first digital asset and a value of said limit order in fiat money.

12. The method of claim 9, wherein each of said one or more price feeds is a block on said blockchain network corresponding to a price feed update transaction on a price of said second digital asset.

13. The method of claim 9, wherein said real-time monitoring of said one or more price feeds is continued until said filling of said limit order is completed by swapping all of said first digital asset for said second digital asset.

14. The method of claim 9, wherein said liquidity pool is created within a defined specific range around said target price as per one or more preset rules maintained in said smart contract.

15. The method of claim 9, wherein said at least one hardware processor is further configured to define a first digital wallet associated with said first digital asset used for placing said limit order from said client device to be a liquidity provider.

16. The method of claim 15, wherein a liquidity fee collected from a second digital wallet associated with said second digital asset against said swapping of said second digital asset for said first digital asset from said liquidity pool is credited to said first digital wallet associated with said first digital asset.
